(19) United States
(12) Patent Application Publication
(10) Pub. No.: US 2007/0125916 A1
(43) Pub. Date: Jun. 7, 2007

(54) Method and System of Marking Location for Installation of a Wall-Box

(75) Inventor: Warren Cullom, Texarkana, TX (US)

Correspondence Address: CONLEY ROSE, P.C., P. O. BOX 3267, HOUSTON, TX, 77253-3267, US

(73) Assignee: Electronic Custom Distributors, Inc. dba Direct Connect, Houston, TX (US)

(21) Appl. No.: 11/560,869

(22) Filed: Nov. 17, 2006

Related U.S. Application Data
(60) Provisional application No. 60/737,684, filed on Nov. 17, 2005.

(51) Int. Cl. F16M 11/00

(52) U.S. Cl. 248/161

(57) ABSTRACT

A method and system of marking location for installation of a wall-box. At least some of the illustrative embodiments are systems comprising a base member that sits upon the floor (the floor defining a horizontal plane), a vertical member coupled to the base member extending substantially perpendicularly from the horizontal plane, a moveable member slidingly coupled to the vertical member (the moveable member selectably positionable along the vertical member), and a marking member coupled to the moveable member. The marking member marks a surface substantially at an elevation of the moveable member.

### CROSS-REFERENCE TO RELATED APPLICATIONS

This application claims the benefit of provisional patent application Ser. No. 60/737,684 filed Nov. 17, 2005 titled “Leveling for installation of fixtures,” and which application is incorporated by reference herein as if reproduced in full below.

### BACKGROUND

Sheetrock is used in construction to cover the studs within walls. Electrical wall-boxes are box-like structures which house devices such as light switches and electric outlets. During new construction the wall-boxes are affixed to the studs within the wall before installation of the sheetrock. Apertures cut in the sheetrock expose the underlying wall-box. For wall-box installation after sheetrock installation, an aperture is cut in the sheetrock and the new wall-box is inserted through the sheetrock (and in some cases affixed to the sheetrock). For aesthetic reasons the wall-boxes housing electric switches are placed at the same elevation (e.g., as measured from the floor), and likewise wall-boxes housing electric outlets are placed at the same elevation.

Whether installed before the sheetrock or after, it is difficult to ensure that the wall boxes are installed at the same elevation, either in relation to a fixed point (e.g., the floor) or in relation to other wall boxes intended to be at the same elevation. Moreover, in the case of installing wall-boxes through existing sheetrock, it is also difficult to set the wall-box in the proper rotational orientation (i.e., having a top and bottom parallel to the floor).

### BRIEF DESCRIPTION OF THE DRAWINGS

For a detailed description of exemplary embodiments of the invention, reference will now be made to the accompanying drawings in which:

FIG. 1 shows a perspective view of a wall-box locator in accordance with at least some embodiments;

FIG. 2 shows a more detailed perspective view of the moveable member of the wall-box locator;

FIG. 3 shows an elevational view of the moveable member; and

FIG. 4 shows a method in accordance with at least some embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. Thus, if a first device couples to a second device, that connection may be through a direct connection or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure is limited to that embodiment.

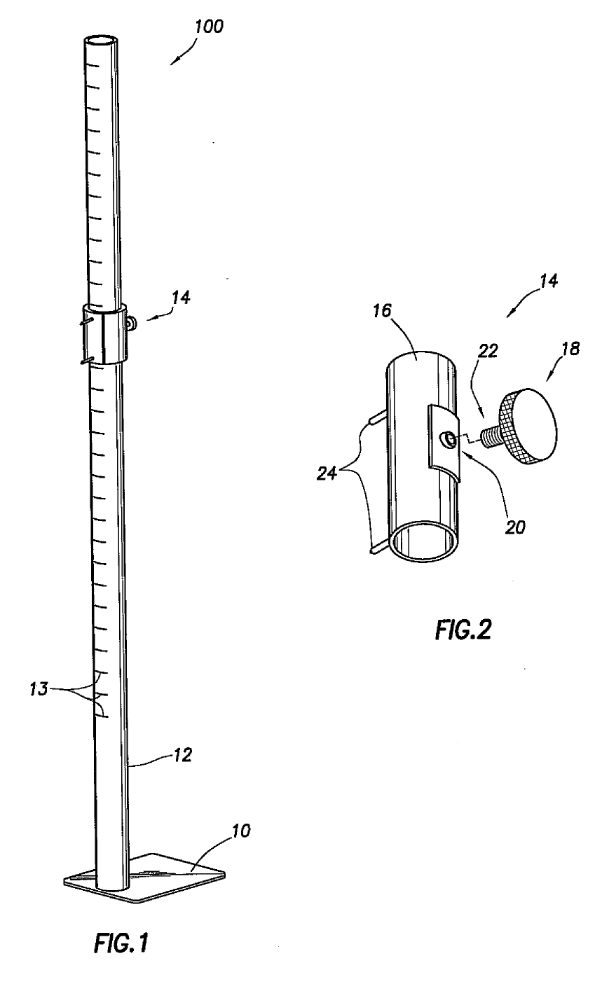

FIG. 1 shows a perspective view of a wall-box locator 100 in accordance with at least some embodiments. In particular, the wall-box locator 100 comprises a base member 10 upon which a vertical member 12 couples. A moveable member 14 is slidingly coupled to the vertical member 12 such that the elevation of moveable member 14 relative to the base member 10 may be selectively changed.

The base member 10 sits upon a horizontal surface, such as the floor. In the illustrative embodiments of FIG. 1, the base member 10 defines a horizontal plane which is parallel to the plane defined by the floor. As discussed more below, the wall-box locator 100 may be used to mark locations for installation of electrical boxes in walls, either before or after installation of the sheetrock. To place appropriate markings the wall-box locator 100 is placed proximate to a wall, and for this reason in some embodiments the vertical member 12 couples to the base member 10 offset from a center of the base member 10. In alternative embodiments, the base member 10 may take other configurations, such as a plurality of legs extending to the floor. In these alternative embodiments, the base member 10 may not define a horizontal plane, but still holds the vertical member 12 in an orientation substantially perpendicular to the horizontal plane defined by the floor. The base member 10 may be made of any suitable material, such as metal, wood, plastic or a combination of these. In some embodiments, the base 10 has a width of approximately 3.8 inches (96 mm) and a length of approximately 4.53 inches (115 mm).

Still referring to FIG. 1, the vertical member 12 of the wall-box locator 100 couples to the base member 10. In some embodiments, the vertical member 12 may be selectively detached from the base member, such as for shipping or storage. The vertical member 12 is illustrated to be tubing or pipe having a substantially circular cross-section; however, other cross-sectional shapes may be equivalently used. For example, in some embodiments the vertical member 12 may be tubing or pipe having semi-circular cross-section. In yet still other embodiments, the vertical member 12 may be square or rectangular tubing. In yet still other embodiments, the vertical member may have any of the previously mentioned cross-sectional shapes, yet be solid, such as a solid circular rod.

In some embodiments the vertical member 12 is single piece structure that couples to base member 10. In alternative embodiments, the vertical member 12 may comprise a plurality of selectably detachable members such that the vertical member 12 may be dissembled for shipping or storage. In accordance with some embodiments, the vertical member 12 is made up of two sections each having a length of three feet; thus, the overall height of the wall-box locator may be approximately six feet when both vertical member 12 sections are installed. Moreover, in embodiments where the vertical member 12 is circular tubing, the internal diameter may be approximately 0.95 inches (24 mm) and the outer diameter may be approximately 1.14 inches (29 mm).

In some embodiments, the vertical member 12 may comprise a plurality of elevation indicating demarcations 13. The demarcations may extend the entire vertical length of the vertical member 12, or may span less than the entire length. The demarcations 13 may indicate elevation (e.g., from the floor) in any suitable system (English units or metric units) and in any suitable increments (e.g., feet, inches, decimeters, centimeters.

FIG. 2 shows an exploded perspective view of the moveable member 14 in accordance with at least some embodiments. In particular, the moveable member 14 in accordance with at least some embodiments comprises a sleeve 16 which, in some embodiments, telescopes over the outer diameter of the vertical member 12 (FIG. 1). In order to hold the sleeve 16 at a particular elevation, the moveable member 14 also comprises a fastener 18, shown here in the form of a threaded screw with a handle. The fastener 18 couples to the sleeve 16 by way of an aperture 20 having mating threads on the internal diameter. To selectively raise and lower the moveable member 14 along the vertical member 12, the fastener 18 is loosened and the sleeve 16 slid along the vertical member 12 in an appropriate direction. Once a desired elevation is achieved, the fastener 18 is screwed in until the distal end 22 contact the vertical member 12, holding the sleeve 16 in place.

Moveable member 14 also comprises a plurality of marking members 24. The marking members 24, as the name implies, are used to mark locations for installation of wall-boxes. FIG. 3 shows an elevational side view of the moveable member 14 in order to discuss the marking members in accordance with at least some embodiments. In particular, in the embodiments illustrated in FIG. 3 two marking members 24 in the form of pins 26 are used. The pins 26 may be metallic, plastic or metal. The proximal ends 28 of the pins 26 have a particular cross-section, while the distal ends 30 having a smaller cross-section. Thus, in these embodiments the pins 26 may be sharpened, at least slightly, to aid in marking locations by placing indentions on sheetrock or wall studs. In alternative embodiments, the marking members 24, in addition to or in place of the indentions, may impart a marking substance onto the sheetrock or wall stud. The marking substance may be, for example, pencil lead, ink, paint, or chalk. In accordance with at least some embodiments, the center-to-center spacing of the marking members 24 may be approximately 3.75 inches (95.25 mm).

In new home construction, many wall-box locations may need to be marked, and thus a marking device that is exceedingly heavy may not be practical to use. In accordance with at least some embodiments, the wall-box locator 100 is constructed mostly of aluminum, and thus even with a six foot vertical member 12, the overall weight is between approximately 6 to 8 pounds.

In accordance with at least some embodiments, selecting the initial elevation of the moveable member 14 involves aligning the marking members 24 with portions of an existing wall-box. For example, faceplates for electrical switches (e.g., light switches) couple to the underlying wall-boxes by way of at least two fasteners, one fastener coupling to a corresponding threaded portion proximate to the top of the wall-box, and the second fastener couple to a corresponding threaded portion proximate to the bottom of the wall-box. By aligning the marking members 24 with the fasteners of the faceplate, an elevation is determined. Similarly, for “decorator” style faceplates for electrical outlets (that is, faceplates that have a single aperture through the faceplate) the faceplates couple to the underlying wall-box by way of at least two fasteners, and thus initial elevation of the moveable member 14 may involve aligning the marking members 24 with the fasteners of the faceplate. In alternative embodiments, the demarcations 13 may be used to select the initial elevation of the moveable member 14, or the user may utilize a tape measure to set the initial elevation.

Regardless of the mechanism by which the initial elevation of the moveable member 14 is set, the wall-box locator 100 may then be moved to a new location where one desire to place an electrical box at a corresponding elevation. At the desired location on the wall, the base member 10 is placed flat on the floor proximate to the wall, and the marking members 24 mark the location. In the case of a wall on which sheetrock has yet to be installed, the marking members 24 may place appropriate marks (e.g., indentations or marks by way of a marking substance) on a wall stud. The marks on the wall stud thus define the upper and lower boundaries of placement of the new wall-box. The process may be repeated for a plurality of wall-box placements, with each placement having the same elevation as defined by the wall-box locator 100. For each placement, the wall box is placed against the stud at the locations indicated by the marks, and the wall box nailed or screwed in place.

In the case of a wall on which sheetrock has been installed, the marking members 24 may place appropriate marks (e.g., indentations or marks by way of a marking substance) on the sheetrock. The wall-box to be installed may be turned and placed aperture first against the sheetrock, with the marks on the sheetrock aligned with corresponding threaded apertures proximate to the upper and lower surfaces of the wall-box. The outline of the wall-box may be traced onto the sheetrock as the pattern for cutting an aperture in the sheetrock. The process of marking the sheetrock, tracing the pattern and cutting an aperture in the sheetrock may be repeated for a plurality of wall-box placements, with each placement having the same elevation as defined by the wall-box locator 100.

The wall-box locator 100 thus performs at least two functions for placement of wall boxes. First, the elevation of the wall boxes, whether installed on a wall before the sheetrock has been installed or after, is guaranteed to be the same because of the use of the wall-box locator 100. Second, in the case of installing through existing sheetrock, the wall-box locator 100 helps ensure that the upper and lower surfaces of the wall box (and therefore the faceplate that attached to the wall-box) are parallel to the floor.

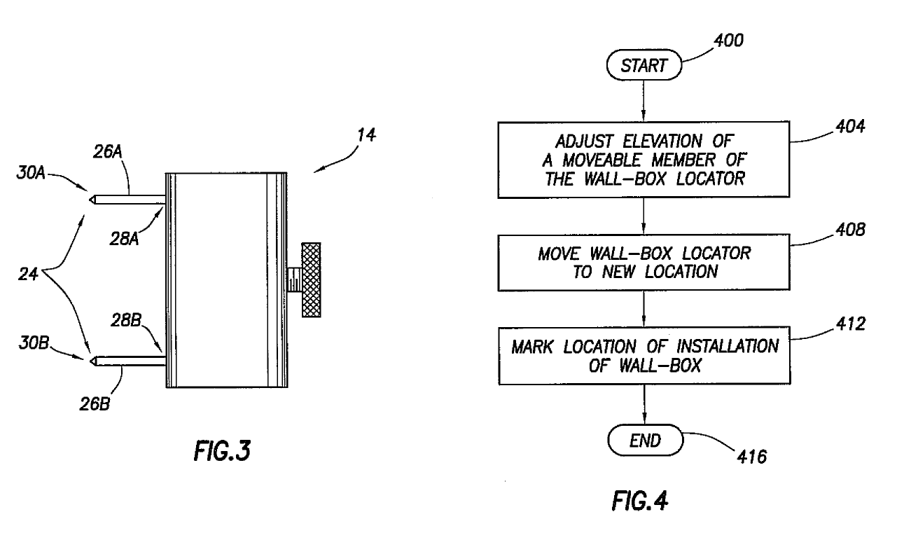

FIG. 4 illustrates a method in accordance with at least some embodiments. In particular, the method starts (block 400) and proceeds to adjusting an elevation of a moveable member 14 of a wall-box locator 100 (block 404). Adjusting the elevation may take many forms. In some embodiments, the wall-box locator 100 is placed proximate to an existing wall-box, and the marking members 24 are aligned with selected portions of the existing wall-box. For example, if the faceplate for the existing wall box is not present, the marking members may be aligned with the threaded apertures to which the faceplate attaches by way of fasteners. If the faceplate is present on the existing wall-box, the marking members may be aligned with the fasteners holding the faceplate in place. In alternative embodiments, possibly where one is not necessarily looking to duplicate the elevation of an existing wall-box, the elevation of the moveable member 14 may be set by demarcations 13 on the vertical member 12, or possibly by way of a measuring tape.

Regardless of the precise mechanism by which the elevation of the moveable member 14 is selected, the next step may be moving of the wall-box locator 100 to another location proximate to a wall (block 408). Whether for a wall already comprising sheetrock or a wall for which sheetrock has yet to be installed, the moving in this illustrative step is to a location where a new wall-box is to be installed. Therefore, the wall-box locator 100 is used to mark a location of installation of a wall-box with the marking members 24 coupled to the moveable member 14 (block 412). In some embodiments, the marking may comprise making indentions in the wall stud or sheetrock. In alternative embodiments, the marking may be way of marking substance. Thereafter, the process ends (block 416).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system comprising:
a base member that sits upon the floor, the floor defining a horizontal plane;
a vertical member coupled to the base member and extending substantially perpendicularly from the horizontal plane;
a moveable member slidingly coupled to the vertical member, the moveable member selectably positionable along the vertical member; and
a marking member coupled to the moveable member, wherein the marking member marks a surface substantially at an elevation of the moveable member.

2. The system as defined in claim 1 wherein the base member further comprises a plate structure that sits upon the floor.

3. The system as defined in claim 1 wherein the base member is made from at least one selected from the group consisting of: wood; metal; or plastic.

4. The system as defined in claim 1 wherein the vertical member further comprises a plurality of demarcations that indicate vertical elevation of the moveable member.

5. The system as defined in claim 1 wherein the vertical member is at least one selected from the group consisting of: a solid circular rod; a solid semi-circular rod; a circular pipe; a semi-circular pipe; square tubing; or rectangular tubing.

6. The system as defined in claim 1 wherein the vertical member is made from at least one selected from the group: wood; metal; or plastic.

7. The system as defined in claim 1 wherein the moveable member telescopes over the vertical member.

8. The system as defined in claim 1 wherein the moveable member further comprises a fastener member, wherein the fastener member selectively fixes the elevational relationship of the moveable member with respect to the vertical member.

9. The system as defined in claim 8 wherein the fastener member further comprises a set screw threadingly coupled to the moveable member.

10. The system as defined in claim 1 wherein the marking member further comprises a first pin projecting from the moveable member, the pin having a distal end of smaller cross section than a proximal end.

11. The system as defined in claim 10 wherein the marking member further comprises a second pin projecting from the moveable member, the second pin having a distal end of smaller cross-section than a proximal end.

12. The system as defined in claim 11 wherein the first and second pins are separated by a distance of approximately 3.75 inches.

13. The system as defined in claim 1 wherein the marking member imparts a marking substance to the surface, the marking substance being at least one selected from the group consisting of: pencil lead; ink; paint; or chalk.

14. The system as defined in claim 1 wherein the system weighs between approximately 6 pounds to 8 pounds.

15. A method comprising:
adjusting an elevation a moveable member of a wall-box location device;
moving the wall-box location device to another location proximate to a wall; and
marking a location of installation of a wall-box on the wall with marking members coupled to the moveable member of the wall box locator.

16. The method as defined in claim 15 wherein adjusting further comprising:
sliding the moveable member along a vertical member to a selected elevation; and
fixing the elevational relationship between the moveable member and the vertical member.

17. The method as defined in claim 15 wherein adjusting further comprises aligning a marking member of the moveable member with selected features of a previously installed wall-box.

18. The method as defined in claim 17 wherein aligning further comprises aligning the marking member with a fastener that attaches a faceplate to the previously installed wall-box.

19. The method as defined in claim 15 wherein marking a location of installation further comprises pressing a marking member of the moveable member into sheetrock to make indentions.

20. The method as defined in claim 15 wherein marking a location of installation further comprises pressing a marking member of the moveable member into a stud to make indentions.

21. The method as defined in claim 15 wherein marking a location of installation further comprises transferring a marking substance from a marking member of the moveable member to the location of installation, the marking substance being at least one selected from the group consisting of: pencil lead; ink; paint; or chalk.
